(19) United States
(12) Patent Application Publication
(10) Pub. No.: US 2015/0278991 A1
(43) Pub. Date: Oct. 1, 2015

(54) METHOD AND SYSTEM FOR IMAGE SCALING

(71) Applicant: Vijay Kumar KODAVALLA, Bangalore (IN)

(72) Inventor: Vijay Kumar KODAVALLA, Bangalore (IN)

(73) Assignee: WIPRO LIMITED, Bangalore (IN)

(21) Appl. No.: 14/283,939

(22) Filed: May 21, 2014

(30) Foreign Application Priority Data
Mar. 27, 2014 (IN) 1644/CHE/2014

(51) Int. Cl. G06T 3/40; G06T 1/60

(52) U.S. Cl. CPC G06T 3/40; G06T 1/60

(57) ABSTRACT

A method, system, and non-transitory computer-readable storage medium for image scaling is provided. In one embodiment, the method may include determining one or more filter phases based on a vertical target grid distance and a horizontal target grid distance; and scaling, by one or more hardware processors, an input image using filter coefficients corresponding to the one or more filters phases to output a target image. The horizontal target grid distance may be based on a ratio of a number of horizontal filter phases and a horizontal scaling ratio, and the vertical target grid distance may be based on a ratio of a number of vertical filter phases and a vertical scaling ratio.

### CROSS-REFERENCE TO RELATED PATENT APPLICATION

The present application claims priority under 35 U.S.C. §119 to Indian Patent Application No. 1644/CHE/2014, filed Mar. 27, 2014, and entitled “METHOD AND SYSTEM FOR IMAGE SCALING.” The aforementioned application is incorporated herein by reference in its entirety.

### TECHNICAL FIELD

The disclosure generally relates to image processing and, more particularly, to image scaling using a poly-phase filter.

### BACKGROUND

Image scaling is an image processing function found in many display devices. Source images are scaled up or down for displaying when source resolution is different than that of display. Such up or down scaling applies to images as well as a video stream.

Conventional image scaling techniques calculate mapping of source pixels and lines to corresponding target pixels and lines based on the specified input and output resolution. Poly-phase filter based image scaling techniques (also referred to herein as “poly-phase filtering”) is an example of conventional image scaling technique. However, poly-phase filtering needs complex floating point arithmetic and expensive divider logic to support a fractional image scaling ratio. Further, it needs complex flow control logic for shifting image data through filters and handling data replication at image boundaries. This is due to the fact that shifting input image data through filters and replication of image data at image boundaries depends on scaling ratios, which can be fractional. As a result, a higher logic gate count is required to carry out the above operations. The higher logic gate count results in a higher power consumption.

The higher logic gate count and power consumption may not be desirable for certain devices, for example, mobile devices where there is a need for low complexity hardware and power consumption.

### SUMMARY

Embodiments of the present disclosure may implement image scaling techniques that can handle fractional image scaling ratios but have low computational complexity and result in lower power consumption.

According to an exemplary embodiment, a method of image scaling is disclosed. The method may include determining one or more filter phases based on a vertical target grid distance and a horizontal target grid distance; and scaling, by one or more hardware processors, an input image using filter coefficients corresponding to the one or more filters phases to output a target image. The horizontal target grid distance may be based on a ratio of a number of horizontal filter phases and a horizontal scaling ratio, and the vertical target grid distance may be based on a ratio of a number of vertical filter phases and a vertical scaling ratio.

According to another exemplary embodiment, a non-transitory computer-readable storage medium is provided that stores instructions which when executed by at least one processor enable the at least one processor to execute a method of image scaling. The method may include determining one or more filter phases based on a vertical target grid distance and a horizontal target grid distance; and scaling, by one or more hardware processors, an input image using filter coefficients corresponding to the one or more filters phases to output a target image. The horizontal target grid distance may be based on a ratio of a number of horizontal filter phases and a horizontal scaling ratio, and the vertical target grid distance may be based on a ratio of a number of vertical filter phases and a vertical scaling ratio.

According to another exemplary embodiment, a system for image scaling is provided. The system may include at least one processor and a memory storing instructions for execution by the at least one processor. The at least one processor may be further configured to determine one or more filter phases based on a vertical target grid distance and a horizontal target grid distance; and scale an input image using filter coefficients corresponding to the one or more filters phases to output a target image. The horizontal target grid distance may be based on a ratio of a number of horizontal filter phases and a horizontal scaling ratio, and the vertical target grid distance may be based on a ratio of a number of vertical filter phases and a vertical scaling ratio

It is to be understood that both the foregoing general description and the following detailed description are exemplary and explanatory only and are not restrictive of the disclosure, as claimed.

### BRIEF DESCRIPTION OF THE DRAWINGS

The accompanying drawings, which are incorporated in and constitute a part of this specification, illustrate exemplary embodiments of the present disclosure and together with the description, serve to explain the principles of the disclosure.

FIG. 1 illustrates an exemplary architecture for image scaling.

FIG. 2 illustrates an exemplary calculation for vertical and horizontal target grid distances.

FIG. 3 illustrates exemplary calculations for vertical and horizontal target grid cumulative distances.

FIG. 4 illustrates an exemplary line buffer.

FIG. 5 illustrates exemplary results for input image line shifting in the line buffer.

FIG. 6 illustrates exemplary filter phases.

FIG. 7 illustrates exemplary filter phase calculations.

FIG. 8 illustrates an exemplary pixel buffer.

FIG. 9 illustrates exemplary results for pixel shifting in the pixel buffer.

FIG. 10 illustrates an exemplary method for image scaling.

### DETAILED DESCRIPTION

Exemplary embodiments of the present disclosure will be described with reference to the accompanying drawings. Wherever possible, the same reference numbers will be used throughout the drawings to refer to the same or like parts. While exemplary embodiments are described herein, modifications, adaptations, and other implementations are possible, without departing from the spirit and scope of the invention. Accordingly, the following detailed description does not limit the scope of the disclosure. Instead, the proper scope of the disclosure id defined by the appended claims.

As used herein, reference to an element by the indefinite article “a” or “an” does not exclude the possibility that more than one of the element is present, unless the contextually requires that there is one and only one of the elements. The indefinite article “a” or “an” thus usually means “at least one.” The disclosure of numerical ranges should be understood as referring to each discrete point within the range, inclusive of endpoints, unless otherwise noted.

As used herein, the terms “comprise,” “comprises,” “comprising,” “includes,” “including,” “has,” “having,” “contains,” or “containing,” or any other variation thereof, are intended to cover a non-exclusive inclusion. For example, a composition, process, method, article, system, apparatus, etc. that comprises a list of elements is not necessarily limited to only those elements but may include other elements not expressly listed. The terms “consist of,” “consists of,” “consisting of,” or any other variation thereof, excludes any element, step, or ingredient, etc., not specified. The term “consist essentially of,” “consists essentially of,” “consisting essentially of,” or any other variation thereof, permits the inclusion of elements, steps, or ingredients, etc., not listed to the extent they do not materially affect the basic and novel characteristic(s) of the claimed subject matter.

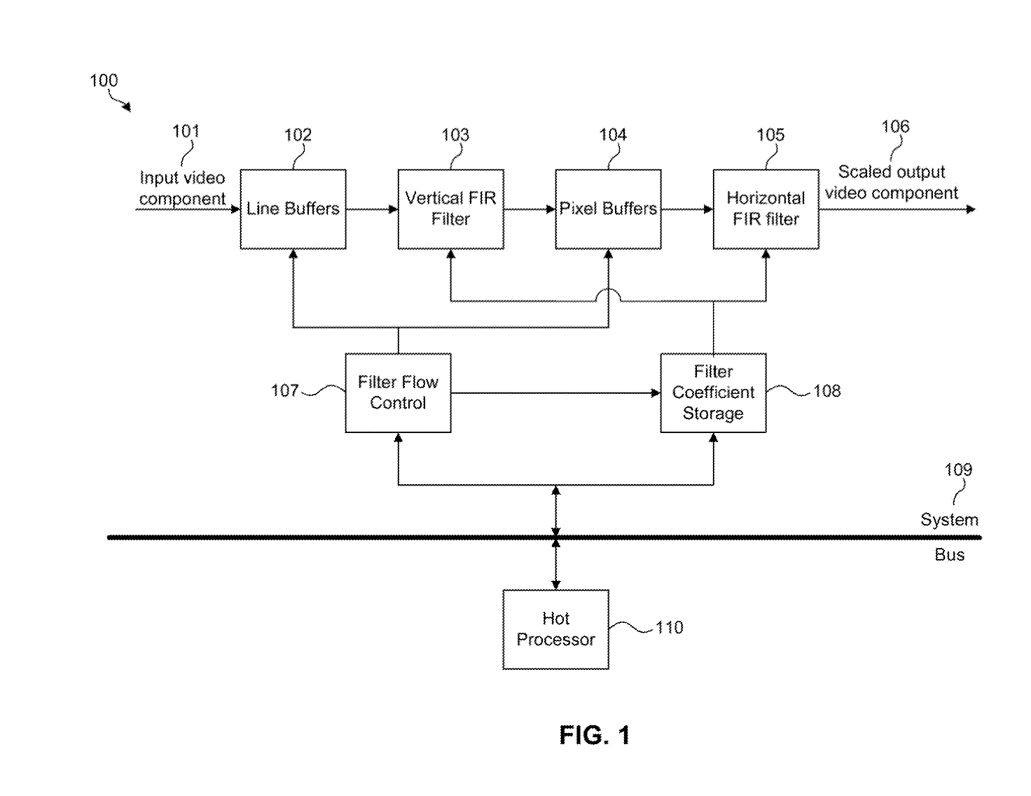

An exemplary apparatus 100 for scaling an input image or video stream 101 is illustrated in FIG. 1. Apparatus 100 may include line buffers 102, vertical FIR filter 103, pixel buffers 104, horizontal FIR filters 105, filter flow control 107, filter coefficient storage 108, system bus 109, and host processor 110. Apparatus 100 may provide a scaled output 106.

Apparatus 100 may be used in a display SoC (system-on-chip). Host processor 110 may be part of the display SoC or may be separate from apparatus 100. For example, host processor 110 may input certain parameters (discussed below) to apparatus 100 through a configuration interface. System bus 109 may connect filter flow control 107 and filter coefficient storage 108 to host processor 110. In one embodiment, flow control 107 and filter coefficient storage 108 may be part of host processor 110.

In an exemplary embodiment, apparatus 100 may perform scaling for a single video component. Accordingly, if the input video stream has more than one component, more than one apparatus 100 may be provided for scaling such a video stream. For example, if the input video has three components (R, G, and B), three apparatuses 100 may be provided with one for each component. Input video may utilize alternate color models (e.g., RYB, CMYK, HSV, HSL, etc.). If multiple apparatuses 100 are provided, such apparatuses 100 may share the same host processor 110. Next, exemplary operations of apparatus 100 are described in detail along with a description for the various components of apparatus 100.

Initially, host processor 110 may compute the parameters: ‘vertical target grid distance’ and ‘horizontal target grid distance.’ The vertical target grid distance may be based on a ratio of a number of filter phases in vertical finite impulse response (FIR) filter 103 and a vertical scaling ratio. The horizontal target grid distance may be based on a ratio of a number of filter phases in horizontal FIR filter 105 and a horizontal scaling ratio. For example, the vertical target grid distance and horizontal target grid distance may be specified as:

Vertical target grid distance=(number of vertical FIR filter phases)/(vertical scaling ratio) (1)

Horizontal target grid distance=(number of horizontal FIR filter phases)/(horizontal scaling ratio) (2)

‘Vertical scaling ratio’ and ‘Horizontal scaling ratio’ may be scaling ratios needed in vertical and horizontal direction of an input image. As an example, consider an input image resolution as X*Y and target image resolution as M*N, where X and M are number of pixels per line and Y and N are number of lines per frame or image. Then the ‘vertical scaling ratio’ and ‘horizontal scaling ratio’ may be N/Y and M/X, respectively.

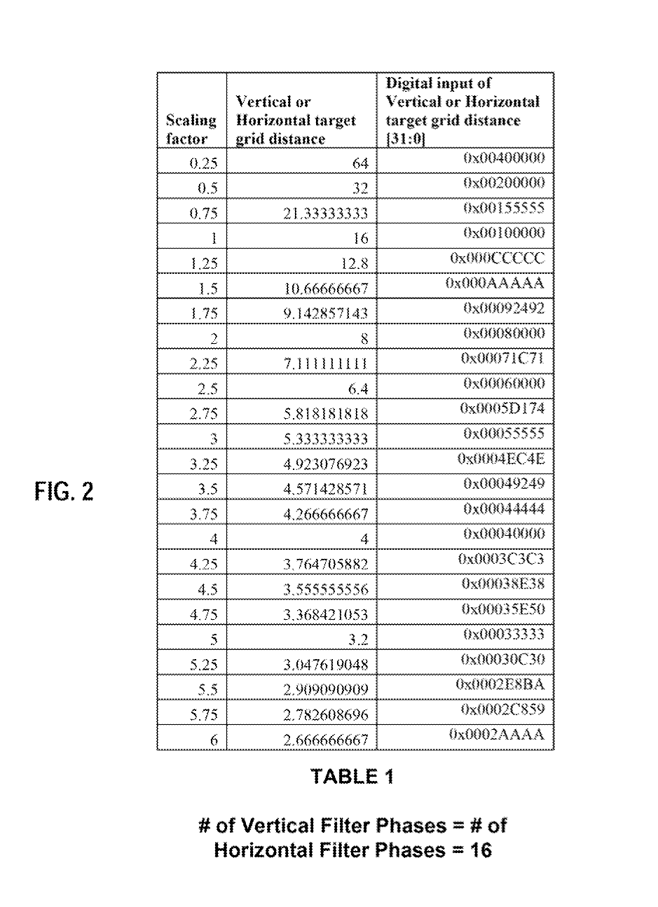

Host processor 110 may pre-compute and store the vertical and horizontal target grid distances for multiple scaling ratios. For example, host processor 110 may pre-compute 32 bit vertical and horizontal target grid distances where the least significant 16-bits may be allocated for a fractional part and most significant 16-bits allocated for the integer part. An exemplary table (TABLE 1) of vertical and horizontal target grid distances where number of filter phases in both horizontal FIR filter 105 and vertical FIR filter 103 is assumed to be ‘16’; is illustrated in FIG. 2. It will be understood that host processor 110 may represent the vertical and horizontal target grid distances in other bit sizes and that the number ‘32’ has been chosen for purposes of illustration.

In an exemplary embodiment, host processor 110 may compute the vertical and horizontal target grid distances on the fly. For example, host processor 110 may determine the input image resolution and the target image resolution selected by a user and compute the vertical and horizontal scaling ratios therefrom. Based on the calculated scaling ratios, host processor 110 may compute the vertical and horizontal target grid distances.

To scale an input video component 101, host processor 110 may determine the input image resolution and target image resolution, and calculate based on that the vertical and horizontal scaling ratios. Host processor 110 may lookup, for example from a table such as TABLE 1 in FIG. 2, corresponding vertical and horizontal target grid distances and provide them to filter flow control 107. For example, host processor 110 may determine that the vertical scaling ratio is 3 and may accordingly provide ‘0x00055555’ as the vertical target grid distance to filter flow control 107. Host processor 110 may determine, for example, that the horizontal scaling ratio is 5 and may accordingly provide ‘0x00033333’ as the horizontal target grid distance to filter flow control 107.

As discussed earlier, filter flow control 107 may be part of host processor 110 and denote logic within host processor 110 that performs certain functions, discussed in the following paragraphs. Alternatively, filter flow control 107 may be a dedicated hardware circuit such as an application specific integrated circuit (ASIC). In another embodiment, filter flow control 107 may be a separate general-purpose processor that is programmed to carry out certain functions.

Filter flow control 107 may determine whether image upscaling or downscaling is desired based on the vertical and horizontal target grid distances provided by host processor 110. It may be determined that vertical upscaling is needed if grid distance [31:16]≦16, else it may be determined that downscaling is needed. For example, if ‘0x00055555’ is the vertical target grid distance input to filter flow control 107, it may be determined that upscaling is needed because vertical target grid distance [31:16] would be ‘0x0005,’ which is less than ‘16’ in decimal. Similarly, filter flow control 107 may determine whether horizontal upscaling or downscaling is needed. The information on whether upscaling or downscaling is needed may be communicated to filter coefficient storage 108, line buffers 102, vertical FIR filter 103, pixel buffers 104, and horizontal FIR filter 105. Alternatively, host processor 110 may directly communicate to filter coefficient storage 108, line buffers 102, vertical FIR filter 103, pixel buffers 104, and horizontal FIR filter 105 whether upscaling or downscaling is needed.

Filter flow control 107 may also compute ‘vertical target grid cumulative distance’ and ‘horizontal target grid cumulative distance’ based on the vertical and horizontal target grid distances provided by host processor 110. For example, ‘vertical target grid cumulative distance’ may be calculated once for each new line in the target image as follows:

vertical target grid cumulative distance=vertical target grid cumulative distance+vertical target grid distance (3)

Similarly, the ‘horizontal target grid cumulative distance’ may be calculated once for each new pixel in every line of target image as follows:

horizontal target grid cumulative distance=horizontal target grid cumulative distance+horizontal target grid distance (4)

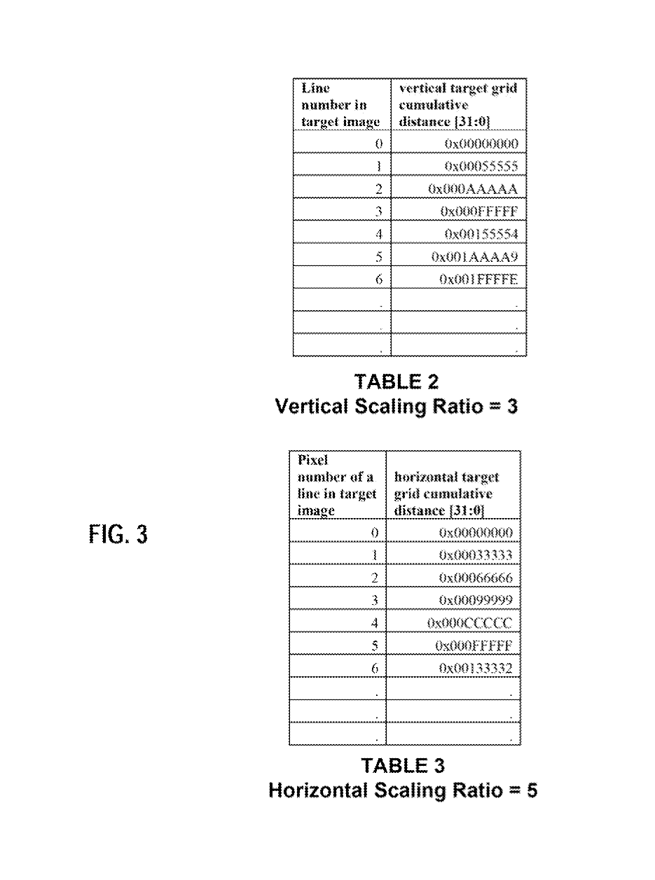

The initial value for vertical and horizontal target grid cumulative distances in (3) and (4) may be set to zero. An exemplary computation for vertical target grid cumulative distances based on an assumed vertical scaling ratio of ‘3’ is illustrated in FIG. 3 as TABLE 2. It will be obvious that a vertical target grid distance of ‘0x00055555’ corresponding to scaling ratio ‘3’ (see FIG. 2), was used in the computation of vertical target grid cumulative distances illustrated in TABLE 3 in FIG. 3. Similarly, an exemplary computation for horizontal target grid cumulative distances for an exemplary horizontal scaling ratio of ‘5’ is illustrated in FIG. 3 as TABLE 3.

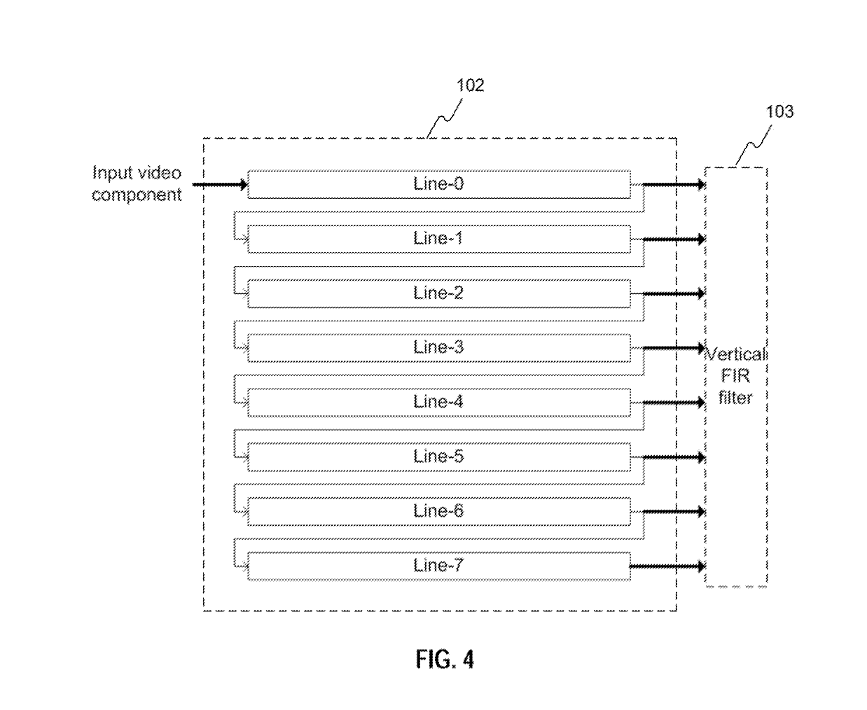

Based on the computed vertical target grid cumulative distance, filter flow control 107 may initiate the generation of each target image line. To generate a target image line, filter flow control 107 may buffer a required number of input image lines in line buffers 102 from input video component 101. An exemplary configuration for line buffers 102 is illustrated in FIG. 4. The number of filter taps in vertical FIR filter 103 may determine the number of input image lines to be buffered. The number of filter taps required may be higher for downscaling than that of upscaling to avoid aliasing artifacts. For purposes of illustration, eight (8) taps are considered for downscaling and four (4) taps are considered for upscaling. Hence, 8 lines (line-0 thru line-7) may be buffered in downscaling case and used to generate a single line in the target image and 4 lines (line-0 thru line-3) buffered for generating a single line in the target image in the upscaling case. Each line buffer may be of size X*bpc, where X is pixels per line in input image and bpc is bits per component.

In addition to determining the number of input image lines that will generate a single target image line, filter flow control 107 may also determine the combination of input image lines that generate a target image line and that have to be shifted into line buffers 102. The input image lines to be shifted into line buffers 102 may be controlled by a parameter ‘Shift_till_input_line’ from filter flow control 107 that may be determined as follows:

Shift_till_input_line(i)=vertical target grid cumulative distance [32:16+P](i)+‘vertical FIR filter taps’>>1 (5)

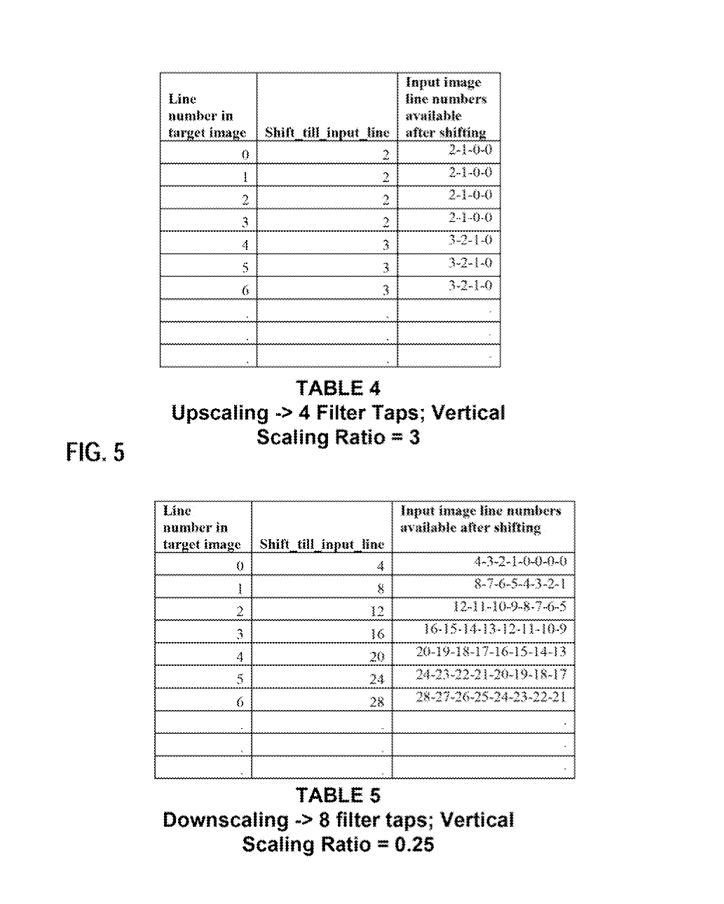

In equation (5), ‘i’ represents the target image line, ‘P’ is number of digital bits needed for representing vertical FIR filter phases. For example, for 16-phase filter P=4. As an example, consider the case that vertical upscaling is needed. In such a case, four input lines (line-0 thru line-3) have to be buffered into line buffers 102. For the target line number 0, Shift_till_input_line=vertical target grid cumulative distance [32:16+4](0)+4>>1, which is equal to two. Accordingly, input images lines shall be shifted into line buffers 102 till input image line number=2. But after this shift, line-2 will hold input image line 0, line-1 will hold input image line 1, and line-0 will hold input image line 2. As line-3 is empty, the line-2 data may be repeated in line-3 buffer as well. An exemplary analysis for certain target image line numbers is provided as TABLE 4 in FIG. 5. TABLE 5 in FIG. 5 illustrates an exemplary analysis for certain target image line numbers for downscaling case with vertical scaling ratio=0.25.

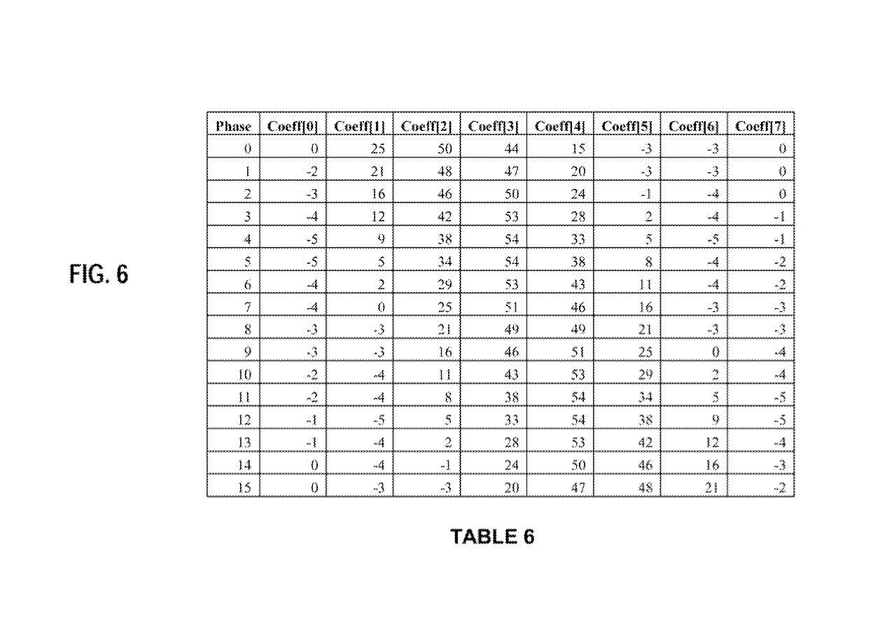

The line buffers 102 may drive out ver_pix_comp[bpc−1:0][7:0] to vertical FIR filter 103. Vertical FIR filter 103 may have several phases and each phase may correspond to certain filter coefficients. For example, FIG. 6 illustrates a TABLE 6 that lists exemplary Lanczos-2 16-phase 8-tap FIR filter coefficients. For each target image line, line buffers 102 output a combination of input image lines, which then need to be filtered using the vertical FIR filter 103. Accordingly, filter flow control 107 may select a filter phase from vertical FIR filter 103 for each target image line. For example, the vertical filter phase may be determined as follows:

vertical FIR filter phase [P−1:0]=vertical target grid cumulative distance [16+P−1:16] (6)

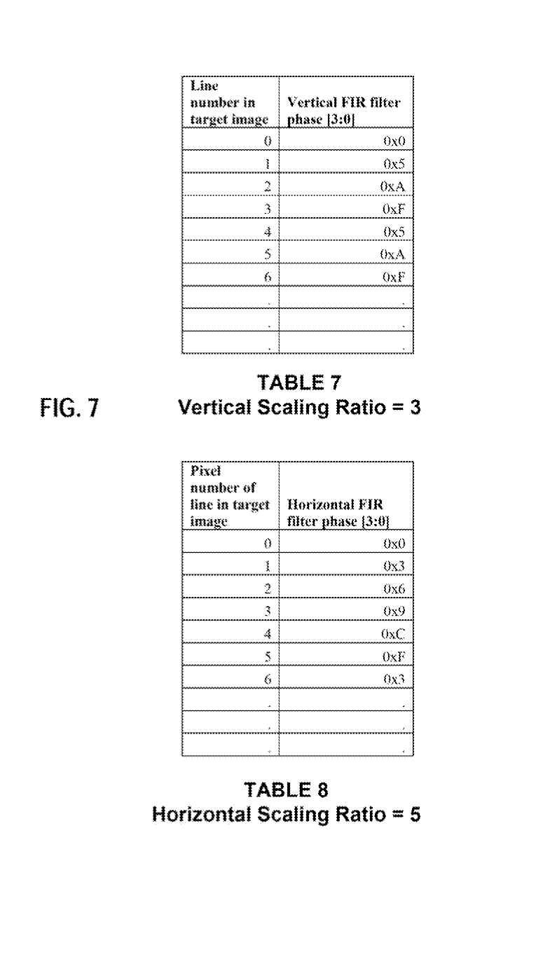

An exemplary table listing the vertical FIR filter phase calculation for vertical scaling factor=3 is illustrated as TABLE 7 in FIG. 7. Once the filter flow control 107 selects a filter phase for a target image line, it may communicate this selection to filter coefficient storage 108, which may store the filter coefficients for each filter phase. Based on the calculated filter phase values, corresponding coefficient values may be and sent to vertical FIR filter 103.

Vertical FIR filter 103 may output a single line of pixels for each target image line as follows:

Vertical FIR filter pixel output=Σver_pix_comp[i]*coeff[i] (7)

In equation (7), i=0 to number of filter taps−1. In case of upscaling, if only four filter taps are used and hence, only four lines are buffered in line buffer 102, only four coefficients (Coeff[0] thru Coeff[3]) may be used for filtering. If downscaling is to be performed and if all eight filter taps are to be used, all coefficients (Coeff[0] thru Coeff[7]) for a given phase may be used in equation (7).

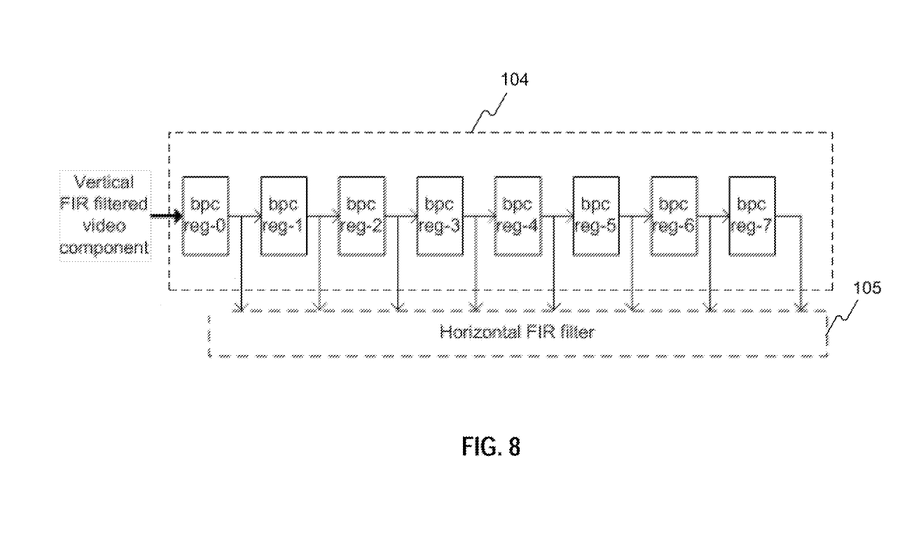

The output of vertical FIR filter 103 may be a plurality of target image lines, the number of which will be based on the target image resolution. For ease of reference, the target image lines output by vertical FIR filer 103 will be referred to as vertically filtered target image lines. Each of the vertically filtered target image lines may undergo filtering through horizontal FIR filter 105 to provide output video component 106. Horizontal FIR filter 105 may output a target image pixel for every target image line. To generate a target image pixel, for a target image line, the pixels of the corresponding vertically filtered target image line may be buffered in pixel buffers 104 illustrated in FIG. 8. The buffering process may be similar to the buffering process described above with respect to line buffers 102. For example, the number of horizontal filter taps may be four for upscaling and eight for downscaling. Accordingly, four pixel buffers may be filled to generate a single target image pixel in the case of upscaling and eight pixel buffers may be filled in the case of downscaling.

In addition to determining the number of pixels that will generate a single target image pixel, filter flow control 107 may also determine the combination of pixels that generate a target image pixel and that have to be shifted into pixel buffers 104. The pixels to be shifted into pixel buffers 104 may be controlled by a parameter ‘Shift_till_input_pixel’ from filter flow control block 107 that may be determined as follows:

Shift_till_input_pixel(i)=horizontal target grid cumulative distance [32:16+P](i)+‘horizontal FIR filter taps’>>1 (8)

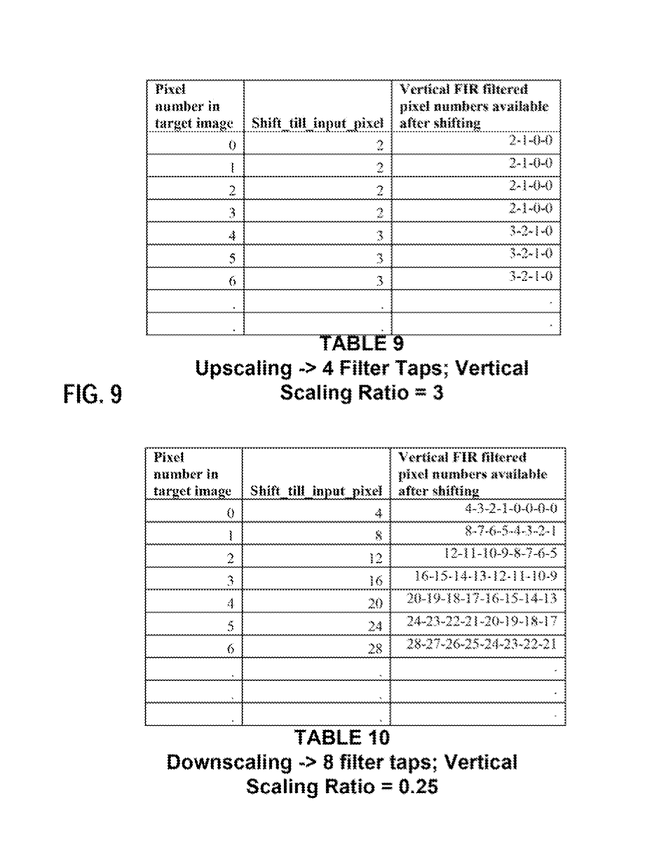

In equation (8), ‘i’ represents the target image pixel, ‘P’ is number of digital bits needed for representing horizontal FIR filter phases. For example, for 16-phase filter P=4. As an example, consider the case that vertical upscaling is needed. In such a case, four pixel buffers (reg-0 thru reg-3) have to be buffered from among pixel buffers 104. For the target image pixel number 0, Shift_till_input_pixel=horizontal target grid cumulative distance [32:16+4](0)+4>>1, which is equal to two. Accordingly, pixels from a vertically filtered target image line shall be shifted into pixel buffers 104 till pixel number 2 is shifted in. After this shifting, reg-2 will hold pixel 0, reg-1 will hold pixel 1, and reg-0 will hold pixel 2. As reg-3 is empty, the reg-2 data may be repeated in reg-3 buffer as well. An exemplary analysis for certain target pixel numbers is provided as TABLE 9 in FIG. 9. TABLE 10 in FIG. 9 illustrates an exemplary analysis for certain target image pixel numbers for downscaling case with vertical scaling ratio=0.25.

The pixel buffers 104 may drive out hor_pix_comp[bpc−1:0][7:0] to horizontal FIR filter 105. Horizontal FIR filter 105 may have several phases and each phase may correspond to certain filter coefficients. In an exemplary embodiment, horizontal FIR Filter 105 may have the same phases and coefficients as illustrated in FIG. 6. For each target image pixel, pixel buffers 104 may output a combination of pixels from a vertically filtered target image line, which then need to be filtered using the horizontal FIR filter 105. Accordingly, filter flow control 107 may select a filter phase for horizontal FIR filter 105 for each target image pixel. For example, the horizontal filter phase may be determined as follows:

horizontal FIR filter phase[P−1:0]=horizontal target grid cumulative distance [16+P−1:16] (9)

An exemplary table listing the horizontal FIR filter phase calculation for horizontal scaling factor=5 is illustrated as TABLE 8 in FIG. 7. Once the filter flow control 107 selects a filter phase for a target image pixel, it may communicate this selection to filter coefficient storage 108, which may store the filter coefficients for each filter phase. Based on the calculated filter phase values, corresponding coefficient values may be and sent to horizontal FIR filter 105.

Horizontal FIR filter 105 may output a single pixel as follows:

Horizontal FIR filter pixel output=Σhor_pix_comp[i]*coeff[i] (10)

In equation (7), i=0 thru number of filter taps−1. It will be apparent that in case of upscaling, if only four filter taps are used and hence, only four pixel registers are buffered in pixel buffers 104, only four coefficients (Coeff[0] thru Coeff[3]) may be used for filtering. If downscaling is to be performed and if all eight filter taps are to be used, all coefficients (Coeff[0] thru Coeff[7]) for a given phase may be used in equation (10).

The pixels and lines used in filtering operation may need special consideration at the boundaries of images. The boundaries of an image include starting pixels of every line, ending pixels of every line, starting lines of every image and ending lines of every image. The number of lines available for filtering at the start and end of an image may be lower than number of taps of a given horizontal or vertical filter. In such a case, first or last lines may be repeated in the start and end of the image as needed for completing the filtering operation. Similarly, the number of pixels available for filtering at the start and end of lines may be lower than number of taps of filter. In such a case, first or last pixels may be repeated in the start and end of every line as needed for completing the filtering operation. The above aspect is built into the Shift_till_input_line (equation (5)) and Shift_till_input_pixel (equation (8)) computations.

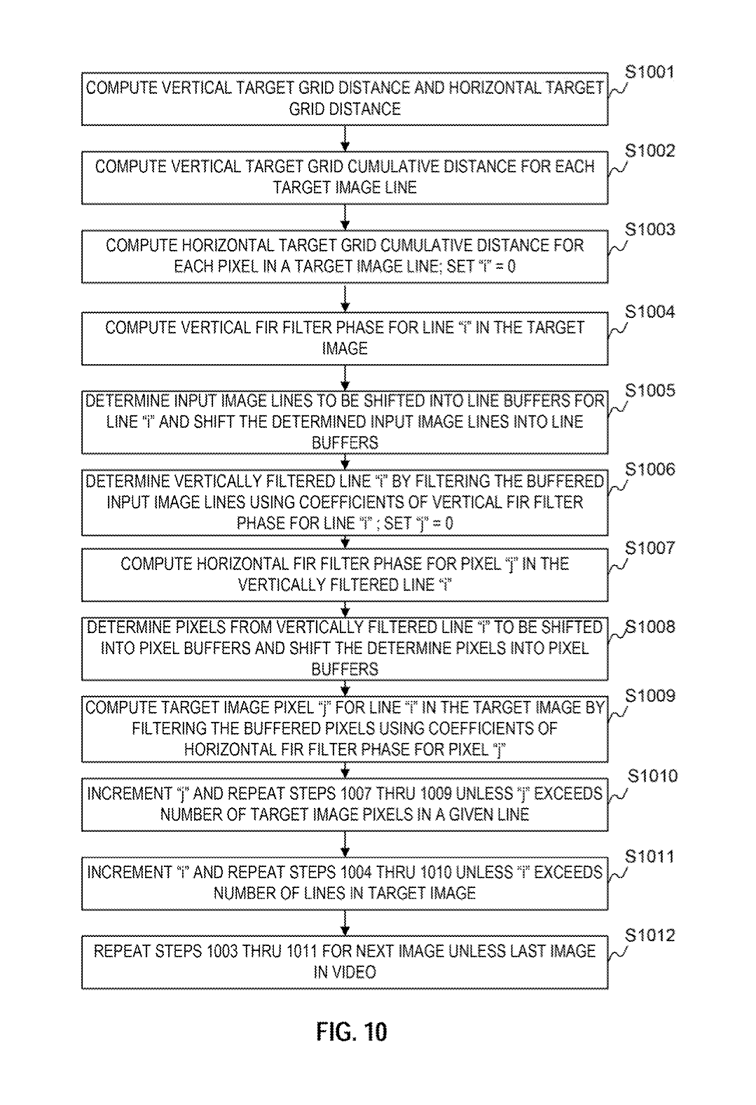

FIG. 10 illustrates an exemplary algorithm that may be implemented by apparatus 100 for scaling an input video component 101 to provide a scaled video component 106. In S1001, host processor 110 may compute the parameters: ‘vertical target grid distance’ and ‘horizontal target grid distance.’ For example, host processor 110 may compute these parameters using equations (1) and (2). In one embodiment, host processor 110 may compute and store the vertical and horizontal target grid distances for multiple scaling ratios as illustrated in FIG. 2. In another embodiment, host processor 110 may compute the vertical and horizontal target grid distances on the fly. For example, host processor 110 may determine the input image resolution and the target image resolution selected by a user and compute the vertical and horizontal scaling ratios therefrom. Based on the calculated scaling ratios, host processor 110 may compute the vertical and horizontal target grid distances.

In S1002, filter flow control 107 may compute a vertical target grid cumulative distance for each new line in the target image. Exemplarily, filter flow control 107 may be provided a vertical target grid distance by host processor 110 based on a determined scaling ratio. Filter flow control 107 may compute for each new line in the target image, also referred to as target image line, a vertical target grid cumulative distance based on, for example, equation (3). An exemplary computation for vertical target grid cumulative distances based on an assumed vertical scaling ratio=3 and number of vertical filter phases=16 is illustrated in FIG. 3 as TABLE 2.

In S1003, filter flow control 107 may compute a horizontal target grid cumulative distance for each pixel in a given target image line. It will be noted that pixels having the same position in different target image lines may have the same horizontal target grid cumulative distance. The horizontal target grid cumulative distance may be calculated using, for example, equation (4). Moreover, in S1003, a parameter “i” may be set to zero to initialize the filtering operation discussed next.

S1004 thru S1010 may be executed for each target image line “i.” In S1004, a vertical filter phase may be determined for vertical FIR filter 103 for target image line “i.” The vertical filter phase determination may be based on the vertical target grid cumulative distance for target image line “i.” Exemplarily, the vertical filter phase may be determined for target image line “i” using equation (6).

In S1005, filter flow control 107 may buffer one or more input image lines in line buffers 102 from input video component 101 required for generating target image line “i.” As discussed earlier, the number of input image lines to be buffered may depend on whether upscaling or downscaling is needed for image lines. To determine the input image lines that need to be buffered to generate target image line “i,” filter flow control 107 may utilize equation (5). The determined input image lines may be shifted in line buffers 102. An exemplary line shifting scenario is illustrated in TABLE 5 in FIG. 5. The line buffers 102 may drive out ver_pix_comp[bpc−1:0][7:0] to vertical FIR filter 103.

In S1006, a vertically filtered line “i” may be determined by filtering the buffered input image lines using coefficients of the vertical filter phase determined in S1004 for line “i.” For example, as set forth in equation (7), the output (verpix_comp[bpc−1:0][7:0]) of line buffers 102 may be multiplied with coefficients of the selected vertical filter phase to generate a vertically filtered line “i.”

The pixels of vertically filtered line “i” may undergo filtering in S1007 thru S1009 to yield a target image pixel in line “i” in the target image. This pixel filtering may be initiated by initializing a parameter “j” to zero. In S1007, filter flow control 107 may compute a phase of horizontal FIR filter 105 for pixel “j” in target image line “i.” The horizontal filter phase determination may be based on the horizontal target grid cumulative distance for target image pixel “j.” Exemplarily, the horizontal filter phase may be determined for target image line “i” using equation (9).

In S1008, filter flow control 107 may buffer one or more pixels from vertically filtered line “i” into pixel buffers 104 for generating target image pixel “j” in target image line “i.” As discussed earlier, the number of pixels to be buffered may depend on whether upscaling or downscaling is needed for horizontal resolution. To determine the pixels that need to be buffered to generate target image pixel “j,” filter flow control 107 may utilize equation (8). The determined pixels may be shifted in pixel buffers 104. An exemplary pixel shifting scenario is illustrated in TABLES 9 and 10 in FIG. 9. The pixel buffers 104 may drive out hor_pix_comp[bpc−1:0][7:0] to horizontal FIR filter 105.

In S1009, a target image pixel “j” may be determined by filtering the buffered pixels using coefficients of the horizontal filter phase determined in S1007. For example, as set forth in equation (10), the output (hor_pix_comp[bpc−1:0][7:0]) of pixel buffers 104 may be multiplied with coefficients of the selected horizontal filter phase to generate a target image pixel “j.”

In S1010, “j” may be incremented and S1007 thru S1010 may be repeated unless “j” exceeds maximum number of pixels in a given target image line. At the end of S1010, a target image line “i” may be available.

In S1011, “i” may be incremented and S1004 thru S1010 may be repeated to generate the next target image line, unless “i” exceeds the maximum number of lines in a given target image.

In S1012, S1003 thru S1011 may be repeated for the next image in the input video stream unless the current image that was processed was the last image.

The various logical blocks in FIG. 1 may be implemented, for example, by a suitable combination of hardware, software, and/or firmware. For example, various general-purpose machines may be used with programs written in accordance with teachings of the disclosure, or it may be more convenient to construct a specialized apparatus or system to perform the disclosed techniques. The general-purpose computer may include a central processing unit (CPU) and memory/storage devices that store data and various programs such as an operating system and one or more application programs. In one embodiment, one or more logical blocks in FIG. 1 may be dedicated hardware circuitry such as an ASIC. In other embodiments, one or more logical blocks in FIG. 1 may be implemented using digital signal processors (DSPs), Field Programmable Gate Arrays (FPGAs), etc. Additionally, the memory storage device of the general purpose computer may include one or more storage devices configured to store information used by the processor or CPU of the general purpose computer to perform certain functions related to disclosed embodiments. The storage device may include a volatile or non-volatile, magnetic, semiconductor, tape, optical, removable, nonremovable, or other type of storage device or computer-readable medium.

Further, apparatus 100 of FIG. 1 may be disposed in communication with one or more input/output (I/O) devices via an I/O interface (not shown). The I/O interface may employ communication protocols/methods such as, without limitation, audio, analog, digital, monaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n/b/g/n/x, Bluetooth, cellular (e.g., code-division multiple access (CDMA), high-speed packet access (HSPA+), global system for mobile communications (GSM), long-term evolution (LTE), WiMax, or the like), etc. For example, input video component 101 may be provided to apparatus 100 through the I/O interface and scaled output video component 106 may be provided by apparatus 100 through the I/O interface.

While an exemplary machine algorithm has been described with reference to FIG. 10, it will be understood that certain exemplary embodiments may change the order of steps in the algorithms or may even eliminate or modify certain steps, or include additional or different steps. Furthermore, each of the steps in the algorithm of FIG. 10 may be embodied as computer-readable instructions or code and stored in a non-transitory computer-readable storage medium for execution by a computer.

Other embodiments of the present disclosure will be apparent to those skilled in the art from consideration of the specification and practice of the embodiments disclosed herein. It is intended that the specification and examples be considered as exemplary only, with a true scope and spirit of the disclosure being indicated by the following claims.

What is claimed is:

1. A method of image scaling, comprising:
determining one or more filter phases based on a vertical target grid distance and a horizontal target grid distance; and
scaling, by hardware circuitry, an input image using filter coefficients corresponding to the one or more filters phases to output a target image,
wherein:
the horizontal target grid distance is based on a ratio of a number of horizontal filter phases and a horizontal scaling ratio, and
the vertical target grid distance is based on a ratio of a number of vertical filter phases and a vertical scaling ratio.

2. The method of claim 1, wherein the horizontal scaling ratio represents a ratio of a number of pixels per line in the target image and a number of pixels per line in the input image.

3. The method of claim 1, wherein the vertical scaling ratio represents a ratio of a number of lines in the target image and a number of lines in the input image.

4. The method of claim 1, wherein determining one or more filter phases based on a vertical target grid distance and a horizontal target grid distance includes:
determining, based on the vertical target grid distance, a vertical target grid cumulative distance for a first line in the target image; and
determining, based on the horizontal target grid distance, a horizontal target grid cumulative distance for a first pixel in the first line in the target image.

5. The method of claim 4, wherein determining one or more filter phases based on a vertical target grid distance and a horizontal target grid distance further includes:
determining, for the first line, a first vertical filter phase based on the vertical target grid cumulative distance for the first line; and
determining, for the first pixel, a first horizontal filter phase based on the horizontal target grid cumulative distance for the first pixel.

6. The method of claim 5, wherein scaling an input image includes:
determining, based on the vertical target grid cumulative distance, a first set of lines from the input image to be buffered for generating the first line; and
generating a vertically filtered first line based on the first set of lines and filter coefficients corresponding to the first vertical filter phase.

7. The method of claim 6, wherein scaling an input image further includes:
determining, based on the horizontal target grid cumulative distance, a first set of pixels from the vertically filtered first line to be buffered for generating the first line; and
generating the first pixel based on the first set of pixels and filter coefficients corresponding to the first horizontal filter phase.

8. A system for image scaling, comprising:
a memory storing instructions;
one or more hardware processors configured to execute the instructions to:
determine one or more filter phases based on a vertical target grid distance and a horizontal target grid distance; and
scale an input image using filter coefficients corresponding to the one or more filters phases to output a target image,
wherein:
the horizontal target grid distance is based on a ratio of a number of horizontal filter phases and a horizontal scaling ratio, and
the vertical target grid distance is based on a ratio of a number of vertical filter phases and a vertical scaling ratio.

9. The system of claim 8, wherein the horizontal scaling ratio represents a ratio of a number of pixels per line in the target image and a number of pixels per line in the input image.

10. The system of claim 8, wherein the vertical scaling ratio represents a ratio of a number of lines in the target image and a number of lines in the input image.

11. The system of claim 8, wherein the one or more hardware processors are configured to determine one or more filter phases based on a vertical target grid distance and a horizontal target grid distance by:
determining, based on the vertical target grid distance, a vertical target grid cumulative distance for a first line in the target image; and
determining, based on the horizontal target grid distance, a horizontal target grid cumulative distance for a first pixel in the first line in the target image.

12. The system of claim 11, wherein the one or more hardware processors are further configured to determine one or more filter phases based on a vertical target grid distance and a horizontal target grid distance by:
determining, for the first line, a first vertical filter phase based on the vertical target grid cumulative distance for the first line; and
determining, for the first pixel, a first horizontal filter phase based on the horizontal target grid cumulative distance for the first pixel.

13. The system of claim 12, wherein the one or more hardware processors are configured to scale an input image by:
determining, based on the vertical target grid cumulative distance, a first set of lines from the input image to be buffered for generating the first line; and
generating a vertically filtered first line based on the first set of lines and filter coefficients corresponding to the first vertical filter phase.

14. The system of claim 13, wherein the one or more hardware processors are further configured to scale the input image by:
determining, based on the horizontal target grid cumulative distance, a first set of pixels from the vertically filtered first line to be buffered for generating the first line; and
generating the first pixel based on the first set of pixels and filter coefficients corresponding to the first horizontal filter phase.

15. A non-transitory computer-readable storage medium storing instructions which when executed by at least one processor enable the at least one processor to execute a method of image scaling, the method comprising:
determining one or more filter phases based on a vertical target grid distance and a horizontal target grid distance; and
scaling, by the at least one processor, an input image using filter coefficients corresponding to the one or more filters phases to output a target image,
wherein:
the horizontal target grid distance is based on a ratio of a number of horizontal filter phases and a horizontal scaling ratio, and
the vertical target grid distance is based on a ratio of a number of vertical filter phases and a vertical scaling ratio.

16. The non-transitory computer-readable storage medium of claim 15, wherein the horizontal scaling ratio represents a ratio of a number of pixels per line in the target image and a number of pixels per line in the input image.

17. The non-transitory computer-readable storage medium of claim 15, wherein the vertical scaling ratio represents a ratio of a number of lines in the target image and a number of lines in the input image.

18. The non-transitory computer-readable storage medium of claim 15, wherein determining one or more filter phases based on a vertical target grid distance and a horizontal target grid distance includes:
determining, based on the vertical target grid distance, a vertical target grid cumulative distance for a first line in the target image; and
determining, based on the horizontal target grid distance, a horizontal target grid cumulative distance for a first pixel in the first line in the target image.

19. The non-transitory computer-readable storage medium of claim 18, wherein determining one or more filter phases based on a vertical target grid distance and a horizontal target grid distance further includes:
determining, for the first line, a first vertical filter phase based on the vertical target grid cumulative distance for the first line; and
determining, for the first pixel, a first horizontal filter phase based on the horizontal target grid cumulative distance for the first pixel.

20. The non-transitory computer-readable storage medium of claim 19, wherein scaling an input image includes:
determining, based on the vertical target grid cumulative distance, a first set of lines from the input image to be buffered for generating the first line; and
generating a vertically filtered first line based on the first set of lines and filter coefficients corresponding to the first vertical filter phase.

21. The non-transitory computer-readable storage medium of claim 20, wherein scaling an input image further includes:
determining, based on the horizontal target grid cumulative distance, a first set of pixels from the vertically filtered first line to be buffered for generating the first line; and
generating the first pixel based on the first set of pixels and filter coefficients corresponding to the first horizontal filter phase.
